(19) United States
(12) Patent Application Publication
(10) Pub. No.: US 2011/0079403 A1
(43) Pub. Date: Apr. 7, 2011

(54) FIRE SAFETY APPARATUS OF HIGH-PRESSURE GAS FUEL TANK FOR VEHICLE

(75) Inventors: Hoonhui Lee, Seoul (KR); Hyungki Kim, Seoul (KR); Sanghyun Kim, Yongin (KR); Kiho Hwang, Yongin (KR)

(73) Assignees: HYUNDAI MOTOR COMPANY, Seoul (KR); KIA MOTORS CORPORATION, Seoul (KR)

(21) Appl. No.: 12/786,912

(22) Filed: May 25, 2010

(30) Foreign Application Priority Data
Oct. 1, 2009 (KR) 10-2009-0093977

(51) Int. Cl. A62C 3/07

(52) U.S. Cl. 169/62

(57) ABSTRACT

The present invention features a fire safety apparatus for a high-pressure gas fuel tank of a vehicle, comprising a pressure relief device that is disposed between a tank connection channel and an outside connection channel in a tank valve of a high-pressure fuel tank and that connects the tank connection channel with the outside connection channel when the tank valve increases in temperature over a predetermined level in a fire, and a suitable intumescent that is hydrate disposed with the high-pressure fuel tank to increase in volume and absorbs heat, with the water from evaporation in a fire, and delay the flames spreading over the high-pressure fuel tank by producing a heat insulation barrier after the water evaporates.

According to preferred embodiments of the present invention, it is possible to prevent a high-pressure fuel tank from exploding due to a fire and to preclude secondary damage due to the high-pressure fuel tank, by delaying the flames spreading over the high-pressure fuel tank with a suitable intumescent that prevents the high-pressure fuel tank from being damaged and exploded by the flames, preferably before a pressure relief device operates in a vehicle on fire.

### CROSS-REFERENCE TO RELATED APPLICATIONS

The present application claims under 35 U.S.C. §119(a) priority to Korean Patent Application Number 10-2009-0093977 filed Oct. 1, 2009, the entire contents of which application is incorporated herein for all purposes by this reference.

### BACKGROUND OF THE INVENTION

1. Field of the Invention

The present invention relates, generally, to a fire safety apparatus of high-pressure gas fuel tank of a vehicle that prevents a high-pressure fuel tank from being damaged and exploded due to heat that is generated in vehicles on fire, before a pressure relief device operates.

2. Description of Related Art

In general, hydrogen fuel cell vehicles or compressed natural gas vehicles are suitably equipped with a high-pressure fuel tank compressing and storing gas-state fuel at high pressure.

Preferably, the high-pressure fuel tank should be able to discharge the high-pressure gas therein by force before it is damaged by high-temperature heat in vehicles on fire; this is prescribed by regulation. This function is typically performed by a pressure relief device provided for a tank valve.

Preferably, a pressure relief device is configured to operate when temperature around it reaches about 110° C.

The pressure relief device can safely discharge gas by operating before the high-pressure fuel tank is damaged in a large fire in which the entire vehicle or the entire fuel system is enveloped in flames, because it is attached to a specific position of the high-pressure fuel tank. However, when only a portion of the high-pressure fuel tank at a distance from the pressure relief device is exposed to flames, heat transfer to the pressure relief device is delayed, such that the high-pressure fuel tank might be damaged and exploded before the pressure relief device operates.

Accordingly, there remains a need in the art for a fire safety apparatus for a high-pressure gas fuel tank of a vehicle.

The information disclosed in this Background of the Invention section is only for enhancement of understanding of the general background of the invention and should not be taken as an acknowledgement or any form of suggestion that this information forms the prior art already known to a person skilled in the art.

### SUMMARY OF THE INVENTION

The present invention features a fire safety apparatus for a high-pressure gas fuel tank of a vehicle that can suitably delay damage to the high-pressure fuel tank due to the heat of a fire to prevent the high-pressure fuel tank from being damaged and exploded before a pressure relief device operates.

In preferred aspects, the present invention provides a fire safety apparatus for a high-pressure gas fuel tank of a vehicle that preferably includes a pressure relief device that is suitably disposed between a tank connection channel and an outside connection channel in a tank valve of a high-pressure fuel tank and suitably connects the tank connection channel with the outside connection channel when the tank valve suitably increases in temperature over a predetermined level in a fire; and a suitable intumescent that is hydrate disposed with the high-pressure fuel tank to suitably increase in volume and absorb heat, with the water from evaporation in a fire, and delay the flames spreading over the high-pressure fuel tank by producing a heat insulation barrier after the water evaporates.

According to a preferred embodiment of the present invention, it is possible to suitably prevent a high-pressure fuel tank from being exploded by a fire and, in further preferred embodiments, to preclude secondary damage due to the high-pressure fuel tank, by delaying the flames spreading over the high-pressure fuel tank with a suitable intumescent for a predetermined time to prevent the high-pressure fuel tank from being damaged and exploded by the flames, before a pressure relief device operates in a vehicle on fire.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is an exemplary perspective view of a high-pressure fuel tank equipped with a pressure relief device.

FIG. 2 is an exemplary cross-sectional view showing the configuration of the pressure relief device.

FIGS. 3 to 6 are exemplary views illustrating a fire safety apparatus for a high-pressure fuel tank using an intumescent according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE INVENTION

As described herein, the present invention includes a fire safety apparatus for a high-pressure gas fuel tank of a vehicle, comprising a pressure relief device, wherein the pressure relief device is disposed between a tank connection channel and an outside connection channel in a tank valve of a high-pressure fuel tank, and an intumescent that is hydrate disposed with the high-pressure fuel tank to increase in volume and to absorb heat.

In one embodiment, the pressure relief device connects the tank connection channel with the outside connection channel when the tank valve increases in temperature.

In another embodiment, the increase in temperature is over a predetermined level in a fire.

In another further embodiment, the intumescent increases in volume and absorbs heat with water from evaporation in a fire, and delays the flames spreading over the high-pressure fuel tank by producing a heat insulation barrier after the water evaporates.

In still another further embodiment, the intumescent is a hydrate or a hydrate-rich compound.

In another embodiment of the present invention, the intumescent further comprises sodium silicate or a mixture of sodium silicate and water.

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Preferred embodiments of the present invention are described hereafter in detail with reference to the accompanying drawings.

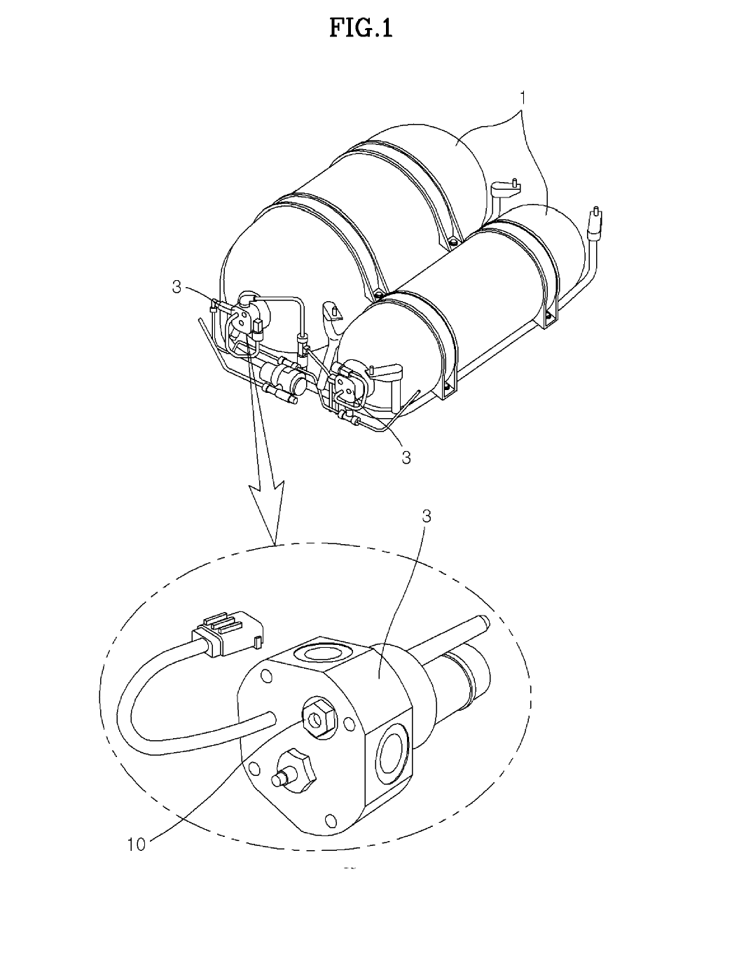

Compressed natural gas vehicles or hydrogen fuel cell vehicles are, for example as shown in FIG. 1, suitably equipped with a high-pressure fuel tank 1 compressing and storing gas-state fuel at high pressure. Preferably, a high-pressure fuel tank 1 should be able to suitably discharge the high-pressure gas therein by force, before it is damaged by high-temperature heat in the vehicles on fire.

Accordingly, for this purpose, in preferred embodiments of the present invention, a high-pressure fuel tank 1 is suitably equipped with a tank valve 3 to supply/discharge fuel and tank valve 3 is suitably equipped with a pressure relief device 10.

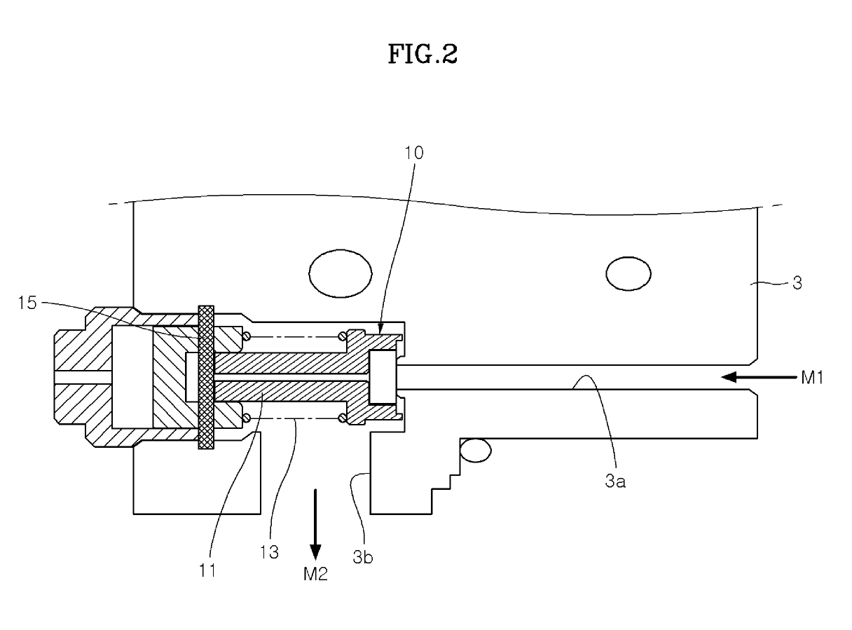

In certain exemplary embodiments, a pressure relief device 10 is, as shown in FIG. 2, suitably disposed between a tank connection channel 3a and an outside connection channel 3b of tank valve 3, and preferably includes a piston 11, a spring 13, and a meltable metal 15 that is easily molten by heat.

Meltable metal 15 normally restrains the movement of a piston 11 and is molten and broken by heat when the temperature of a tank valve 3 reaches about 110° C., and, accordingly, as meltable metal 15 is broken, the piston 11 is moved from the position shown in FIG. 2 to the left by the gas pressure inside high-pressure fuel tank 1.

Therefore, according to certain preferred embodiments of the present invention, the tank connection channel 3a and outside connection channel 3b are suitably connected, such that the gas in the high-pressure tank 1 is rapidly discharged outside.

A pressure relief device 10 can normally operate and safely discharge the gas in a high-pressure fuel tank 1 before the high-pressure fuel tank 1 is suitably damaged, but only in a large fire in which the entire vehicle or the entire fuel system is enveloped in flames, because it is installed at a specific position (tank valve) of high-pressure fuel tank 1.

However, when only a portion of high-pressure fuel tank 1 at a distance from pressure relief device 10 is suitably exposed to a fire, heat transfer to a pressure relief device 10 is delayed, such that high-pressure fuel tank 1 might be suitably damaged and exploded before pressure relief device 10 operates.

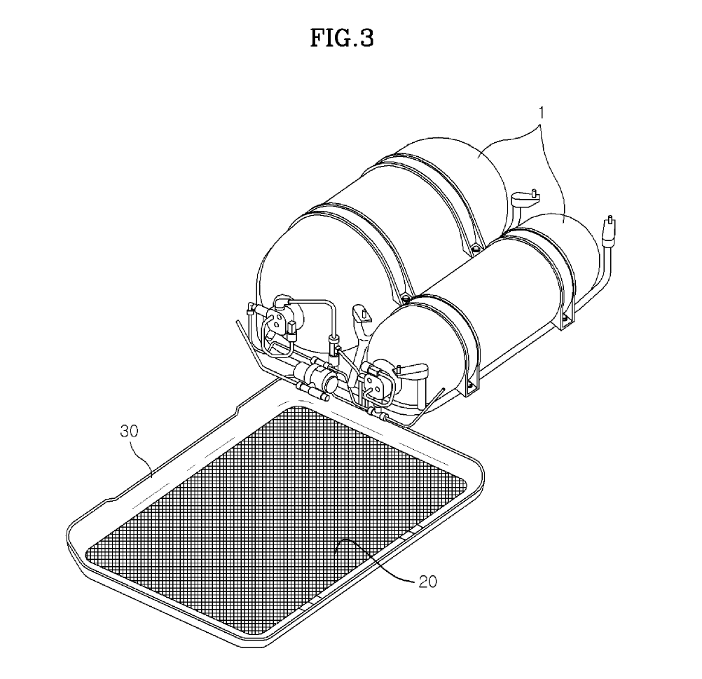

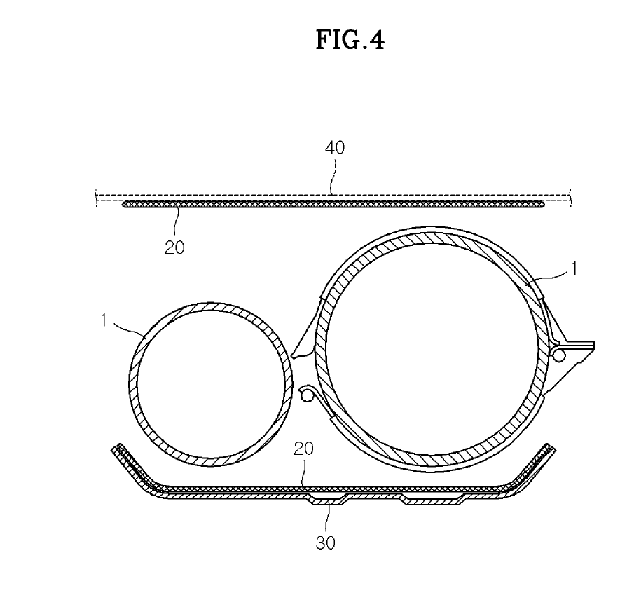

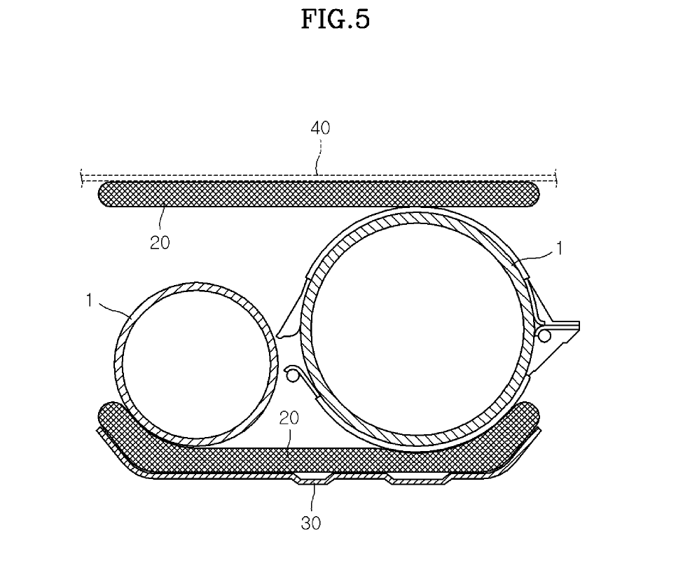

Accordingly, an embodiment of the present invention features a new additional component capable of suitably delaying the flames spreading to high-pressure fuel tank 1 to suitably preclude the above problem, wherein and the new additional component is intumescent 20 that is installed with high-pressure fuel tank 1, as shown in FIGS. 3 to 5.

Preferably, intumescent 20 is hydrate containing water and suitably increases in volume and absorbs heat while the water is evaporated by heat in a fire. Further, it suitably delays the flames spreading to a high-pressure fuel tank 1 by suitably forming a heat insulation barrier, using the increased volume, after the water evaporates.

In certain preferred embodiments, the present invention uses hydrate or a hydrate-rich compound, typically sodium silicate or a mixture of sodium silicate and water, for intumescent 20; however it is to be understood by one of skill in the art that the present invention is not limited thereto.

According to preferred embodiments, the vehicle body is suitably equipped with a protector 30 to suitably protect the high-pressure fuel tank 1 from substances (stones, cans etc.) on the road while the vehicle is traveling. Preferably, when the high-pressure fuel tank 1 is suitably disposed over the protector 30, intumescent 20 is suitably applied on the protector 30.

According to further preferred embodiments of the present invention, in order to take precautions against a fire inside vehicles, intumescent 20 is suitably applied to the bottom of the vehicle body where the high-pressure fuel tank 1 is suitably disposed, or the high-pressure fuel tank 1 is seated on the roof panel of buses, such that intumescent 20 is suitably applied to the roof panel where high-pressure fuel tank 1 is disposed.

According to other further embodiments, when a vehicle body panel 40 is suitably disposed over the high-pressure fuel tank 1, it is also possible to apply intumescent 20 to a vehicle body panel 40 to suitably reinforce the protective function of a high-pressure fuel tank 1.

Accordingly, in a vehicle on fire, the water contained in intumescent 20 suitably absorbs heat while being evaporated by the heat of the fire and intumescent 20 suitably expands.

Preferably, expanding intumescent 20 produces a heat insulation barrier, using the increased volume after the water evaporates, and accordingly, the flames spreading over high-pressure fuel tank 1 is suitably delayed for a predetermined time.

According to further preferred embodiments of the present invention, a pressure relief device 10 of the high-pressure fuel tank 1 operates while the flames spreading over the high-pressure fuel tank 1 are suitably delayed by intumescent 20, and accordingly, the high-pressure fuel tank 1 can suitably discharge the high-pressure gas therein to the outside, before it is damaged and exploded by the heat.

Accordingly, the high-pressure fuel tank 1 does not explode even if it is damaged and broken after discharging the high-pressure gas, and further, such that it is possible to preclude secondary damage due to high-pressure fuel tank 1.

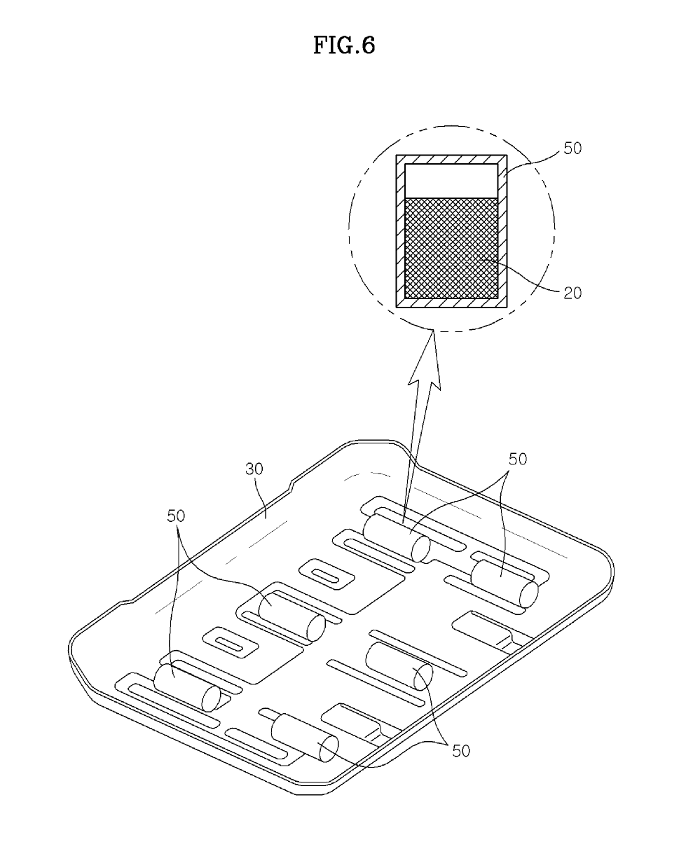

Preferably, intumescent 20 used in this embodiment of the present invention can be suitably stored in a vessel 50 having a predetermined space, for example as shown in FIG. 6.

In certain preferred embodiments, vessels 50 with intumescent 20 therein are suitably fixed over protector 30, or to the vehicle body panel or the roof panel where the high-pressure fuel tank 1 is suitably disposed.

Preferably, in further exemplary embodiments, the vessel 50 should be torn or broken with ease when intumescent 20 expands with the water evaporating, not restricting or reducing the function of the intumescent 20.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fire safety apparatus for a high-pressure gas fuel tank of a vehicle, comprising:
a pressure relief device disposed between a tank connection channel and an outside connection channel in a tank valve of a high-pressure fuel tank, wherein the pressure relief device connects the tank connection channel with the outside connection channel when the tank valve increases in temperature over a predetermined level in a fire; and
an intumescent that is hydrate disposed with the high-pressure fuel tank to increase in volume and absorb heat, with the water from evaporation in a fire, and delay the flames spreading over the high-pressure fuel tank by producing a heat insulation barrier after the water evaporates.

2. The fire safety apparatus for a high-pressure gas fuel tank of a vehicle of claim 1, wherein the intumescent is a hydrate or a hydrate-rich compound and simultaneously sodium silicate or a mixture of sodium silicate and water.

3. The fire safety apparatus for a high-pressure gas fuel tank of a vehicle of claim 1, wherein the intumescent is applied to a protector disposed on a vehicle body to protect the high-pressure fuel tank.

4. The fire safety apparatus for a high-pressure gas fuel tank of a vehicle of claim 1, wherein the intumescent is applied to a vehicle body panel or a roof panel where the high-pressure fuel tank is disposed.

5. The fire safety apparatus for a high-pressure gas fuel tank of a vehicle of claim 1, wherein the intumescent is stored in a vessel that is torn or broken when the intumescent expands with the water evaporating, a plurality of vessels with intumescents therein is fixed to a protector disposed on the vehicle body to protect the high-pressure fuel tank, or the vehicle body panel or the roof panel where the high-pressure fuel tank is disposed.

6. A fire safety apparatus for a high-pressure gas fuel tank of a vehicle, comprising
a pressure relief device, wherein the pressure relief device is disposed between a tank connection channel and an outside connection channel in a tank valve of a high-pressure fuel tank; and
an intumescent that is hydrate disposed with the high-pressure fuel tank to increase in volume and to absorb heat.

7. The fire safety apparatus of claim 6, wherein the pressure relief device connects the tank connection channel with the outside connection channel when the tank valve increases in temperature.

8. The fire safety apparatus of claim 7, wherein the increase in temperature is over a predetermined level in a fire.

9. The fire safety apparatus of claim 6, wherein the intumescent increases in volume and absorbs heat with water from evaporation in a fire, and delays the flames spreading over the high-pressure fuel tank by producing a heat insulation barrier after the water evaporates.

10. The fire safety apparatus for a high-pressure gas fuel tank of a vehicle of claim 6, wherein the intumescent is a hydrate or a hydrate-rich compound.

11. The fire safety apparatus for a high-pressure gas fuel tank of a vehicle of claim 10, wherein the intumescent further comprises sodium silicate or a mixture of sodium silicate and water.
